(19) United States
(12) Patent Application Publication
(10) Pub. No.: US 2008/0023460 A1
(43) Pub. Date: Jan. 31, 2008

(54) Garment with heating assembly

(75) Inventor: Charlie Huang, Taipei (TW)

Correspondence Address: BACON & THOMAS, PLLC, 625 SLATERS LANE, FOURTH FLOOR, ALEXANDRIA, VA, 22314, US

(73) Assignee: Petatech International Co., Ltd., Taipei (TW)

(21) Appl. No.: 11/798,665

(22) Filed: May 16, 2007

(30) Foreign Application Priority Data
Jul. 26, 2006 (TW) 095127231

(51) Int. Cl. H05B 1/00; A41D 1/00

(52) U.S. Cl. 219/211; 2/69

(57) ABSTRACT

A heat producing garment with a separate control. The garment comprising a power source and a heating package located at the specific part of the garment and including; a heating device energized by the power; and a control circuit for controlling the heating status of the heating device; and a switch assembly separated from and electrically connected with the heating package allowing control of the on/off status of the heating device. The separation of the control from the garment would allow the heating of the garment to be easily controlled, allow the control to be encased in a hard protection, and allow the control to be replaced if broken.

### FIELD OF THE INVENTION

The invention relates to a wear that includes a heating assembly within, more particularly to a wear that includes a heating assembly within that is controlled by a switch assembly separate from the heating assembly.

### BACKGROUND OF THE INVENTION

Diving and surfing are popular pastimes of the modern day. A major concern to participants of such activities is the adverse effects caused by exposure to cold environments, such as hypothermia and frostbite. Even if it is not cold enough to cause such afflictions, the discomfort from the cold stops many people from enjoying these pastimes.

In order to protect surfers and divers from the cold, producers of water sport equipment have first tried making diving suits out of thick rubber in order to insulate the user from the cold. However, not only did the thick rubber limit the movement of the user, it also did not provide adequate warmth because the suit itself had no source of heat.

In U.S. Pat. No. 6,802,081, the applicant proposed a heating suit that produced heat by using a chemical reaction. This chemical reaction takes place in a phase change fiber that produces heat by absorbing moisture. Supposedly, this suit provides suitable warmth and flexibility for the user. Yet there are many flaws to this invention. The moisture used in the chemical reaction is provided from the sweat of the wearer, which means that the heating process is slow and unstable. Furthermore it is illogical to use human sweat to regulate the heating system due to the inherent positive feedback loop; a hot person would sweat and be heated from the suit, while a cold person would not sweat and not receive any heating from the suit. Hence this heating suit is highly impractical.

There is also the possibility of using other phase change reactions (such as thermo-pads) to provide heat for a diver, yet the heat release of these reactions cannot be stopped once they are started; hence the duration and controllability of these reactions are very limited.

One successful solution has been to use electricity to provide heat for the diver, more specifically the usage of a Joule heating assembly (passing electricity through a heating wire to generate heat). FIG. 1 shows a conventional electrical heating assembly for diving suits, which comprises of a power source, a heat source, a temperature sensor, a switch assembly and a micro-controller. Once the user turns on a switch in the switch assembly, the power sources provides energy to heat the heat source. In turn, the temperature of the heating assembly is monitored by a temperature sensor that Would send signals to the micro-controller, which would turn off the heating assembly once a desired temperature is reached.

As shown in FIG. 1, when a heating assembly is placed near the torso of the user, it is common to place the heating device 11 and the temperature sensing module in a bag 10, while placing the micro-controller 12, switch assembly 14 and other electrical components onto an electrical circuit board 16. The electrical circuit board 16 is placed with the power source 18 on the chest or back of the user in order to take advantage of the greater surface area provided there relative to other parts of the body. The fact that many electrical components are placed onto a single electrical circuit board 16 reduces the production cost for the producer. This also reduces the number of separate components and hence makes it easier for a producer to attach the heating assembly to the diving suit.

Yet this design forces users to lower their head to look at the controls on their chest in order to control the temperature of the suit, which is not very convenient. Also the switch assembly itself must be hard in order to have the user differentiate between operating the switch and the natural give of all materials. For example, if a mouse button was soft, when the user presses the button he/she would not be able to tell if he/she has successfully clicked the mouse or whether he/she has merely felt the give of the soft button. This means that the switch assembly is vulnerable to impact. Furthermore, if the switch assembly is broken, the switch assembly cannot be replaced because the switch assembly is built into the circuit board, and hence the entire heating assembly would be rendered useless.

Shown in FIG. 2 and FIG. 3 is U.S. Pat. No. 6,649,873, where a power source 28 and a control circuit are placed in a hard shell 20. The shell 20 controls the temperature of heating wire 21 and is detachable from the heating suit 2.

But the use of a shell 20 greatly increases the size of the heating assembly, creating a big bulge in heating suit 2. Not only does this cause major discomfort for the user, the fact that the heating suit 2 is meant for water sports means that the shell 20 would restrict the movement of the user and be prone to break from impact. Also this design places the switch assembly 24 on the inside of the heating suit 2, which makes it hard to control the heating assembly. If the suit were to be adapted to provide heat for mountain climbers, it would be preposterous to imagine that mountain climbers must open their jacket in the midst of freezing winds to control the heating assembly.

Therefore, it is desired to provide a heating suit control that has comfort, ease of use and an easily replaceable power switch without having to dramatically raise the production cost.

### SUMMARY OF THE INVENTION

A primary objective of the present invention is to provide a heating suit with an easy to use and separate switch assembly.

A secondary objective of the present invention is to provide a heating suit with a control circuit that is protected from damage due its separation from the vulnerable switch assembly.

A third objective of the present invention is to provide a heating suit with a separate switch assembly that is replaceable if broken, thus elongating the lifetime of the entire product.

The present invention is a garment, a specific part wherein adapted to give off heat, the garment comprising: a power; a heating package located at the specific part of the garment and including: a heating device energized by the power; and a control circuit for controlling the heating status of the heating device; and a switch assembly separated from and electrically connected with the heating package allowing control of the on/off status of the heating device.

The feature of the present invention resides in the fact that the main body and the switch assembly of the heating assembly are separate, which allows the switch assembly to be placed near the hands of the user for ease of use. The separation of the switch assembly from the main body also ensures that the switch assembly is easily replaceable if broken, thus elongating the lifetime of the entire product. Also since the switch assembly must be hard, its separation from the main body allows the main body to be made of flexible electronics (most likely a flexible circuit board). This means that the main body could be folded or sewed into the heating suit without the need of a hard shell to protect the main body, thus providing comfort for the user and reducing the vulnerability of the main body to impact. With these features the invention fulfills each objective without dramatically increasing the invention's production cost.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a conventional diving suit equipped with an electrical heat assembly;

FIG. 2 is a schematic side view of the suit proposed in U.S. Pat. No. 6,649,873;

FIG. 3 is a schematic front view of the suit in FIG. 2;

FIG. 4 is a perspective view of the first preferred embodiment of the present invention;

FIG. 5 is a diagram illustrating the relationship between the heating device, control circuit, power source and switch assembly;

FIG. 6 is a perspective view of the suit in FIG. 4 illustrating the location of the container and the switch assembly; and

FIG. 7 is a perspective view of the second preferred embodiment of the present invention.

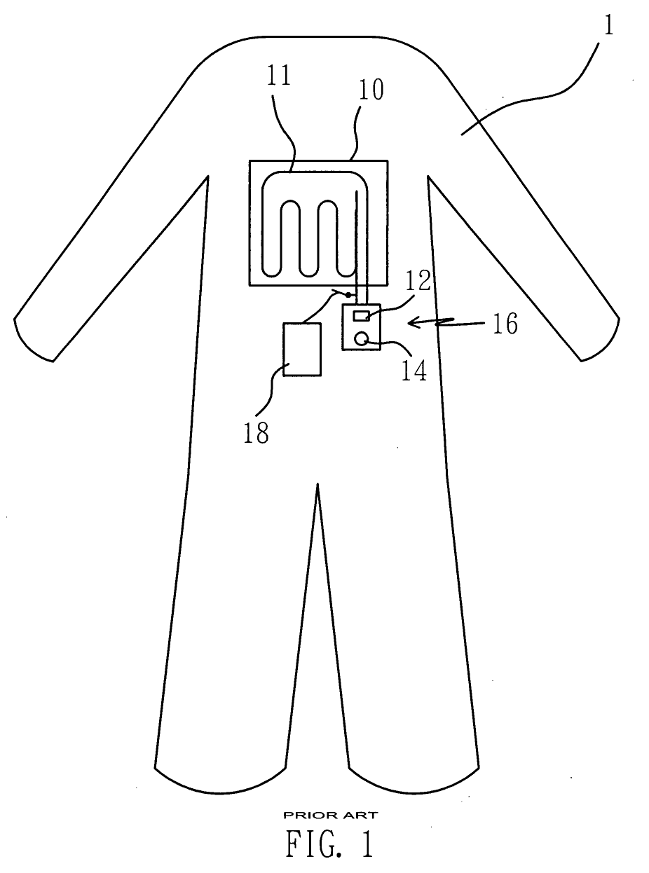

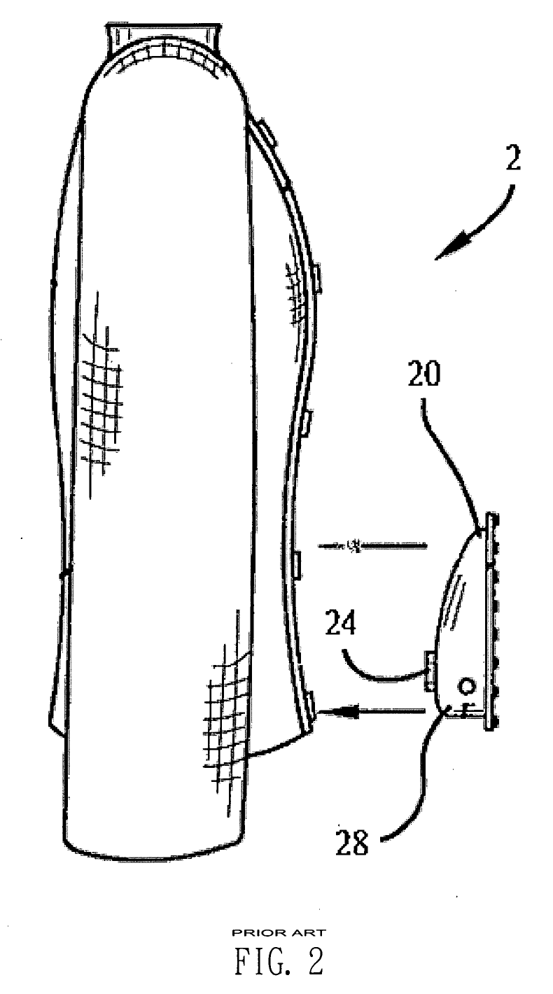

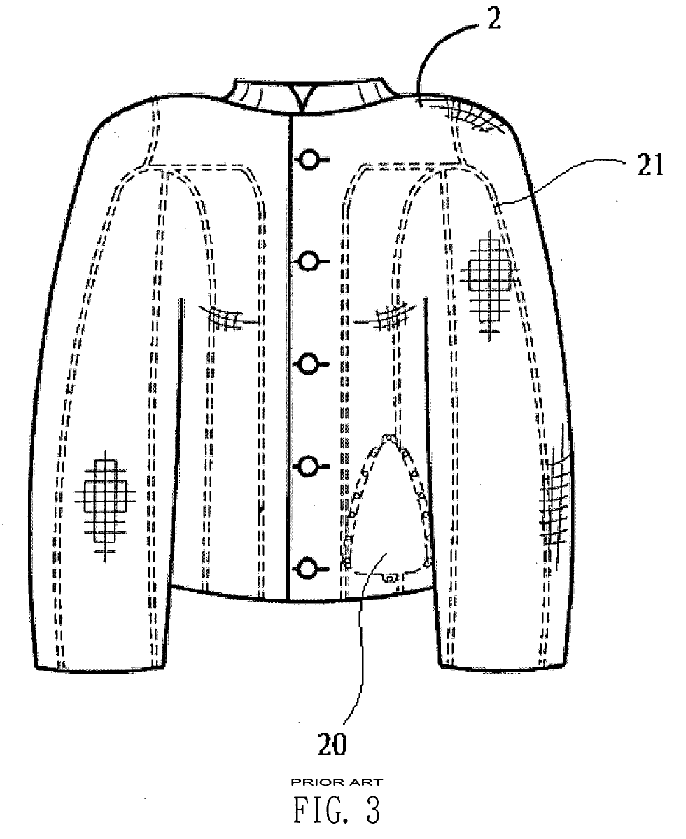

### DETAILED DESCRIPTION OF THE PREFERRED EMBODIMENT

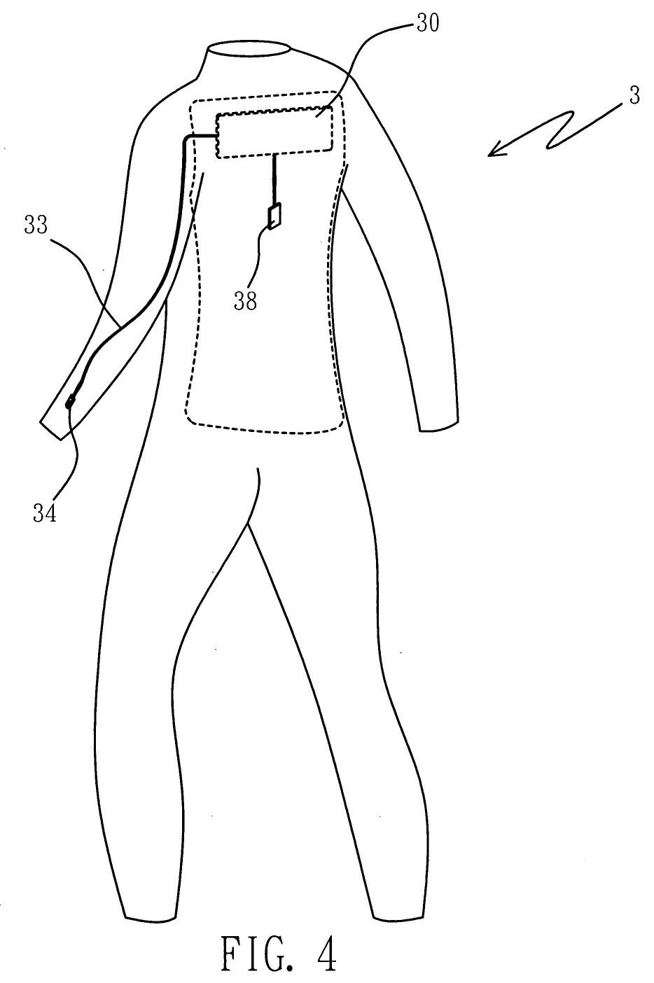

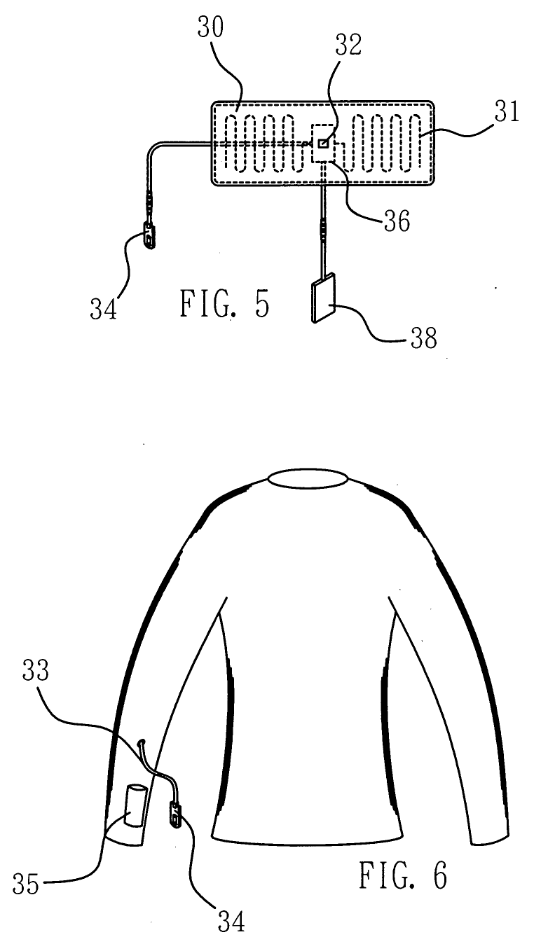

Referring to FIGS. 4 and 5, the first preferred embodiment of this invention is a diving suit 3 made of artificial rubber, with a heating assembly located at the back of a torso the diving suit 3. This heating assembly uses a battery 38 as a power source and a carbon fiber heating wire 31 as a heating medium. A switch assembly 34 and a micro-controller 32 determine whether heating wire 31 is heated or not. The heating wire 31 and a temperature sensor are covered by an insulating resin 30. The temperature sensor sends temperature readings to micro-controller 32.

Because the micro-controller 32 in the control circuit 36 is separated from the switch assembly 34, the micro-controller 32 could be made of flexible electronics and enveloped in the same insulating resin 30 as the heating wire 31 and the temperature sensor. The micro-controller 32 could even be sewed within the layers of the diving suit corresponding to the chest or back of the wearer, thus reducing the micro-controller's 32 chance of breaking under impact and the restrictions the invention has on the user's movement. Compared to the prior art that uses a shell housing to enclose the control circuit, this invention is much more comfortable.

The switch assembly 34 of the control circuit 36 is separate from the control circuit 36, and is connected to the micro-controller 32 by an electrical wire 33 that is enclosed in an electrically insulating material. As shown in FIG. 6, electrical wire 33 could be attached along the sleeves of the diving suit to place the switch assembly 34 near the wrist of the user, where a container 35 is attached to hold the switch assembly 34 to protect the switch assembly 34 from outer impact. Thus the user would be able to easily control the heating assembly by manipulating the switch assembly 34 on his/her wrist. Furthermore, the switch assembly 34 could be designed to be controllable even when enclosed in the container 35, such as having a transparent layer on the container 35 that would allow the user to see and manipulate the switch assembly.

Switch assembly 34 might be damaged due to its placement on the user's wrist, which may be subject to rigorous movement. Even if switch assembly 34 is damaged, it could be easily replaced because it is separate from control circuit 36. Thus the entire diving suit, which may cost up to hundreds of dollars, would not become totally worthless if a single switch assembly 34 is broken.

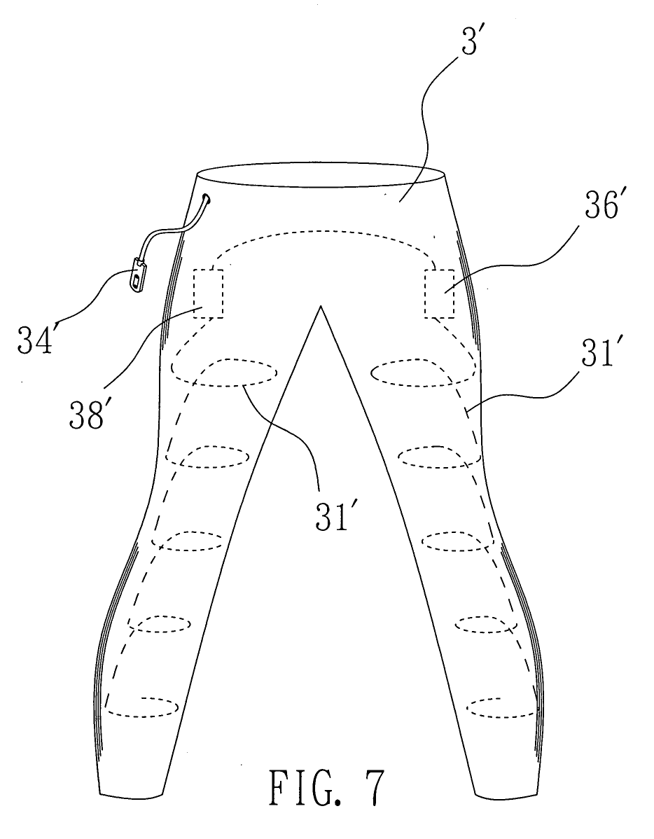

Those skilled in the art would recognize the fact that the heating device doesn't have to be enclosed with the control circuit. FIG. 7 shows the second preferred embodiment of the present invention, where the heating wire 31′ is simply covered in a electrically insulating material and sewn into heating suit 3′. In fact, if the heating suit is not meant for water activities, the heating wire would not have to be insulated due to the smallness of the voltage and current in the assembly.

In this case, the control circuit 36′ would be placed within the suit, while switch assembly 34′ and battery 38′ would be placed in a pocket of the suit, thus allowing for ease of control of the heating device. The separation of the control circuit 36′ and the switch assembly 34′ allows the control circuit 36′ to be made of a soft material, which means that the suit would also be soft and comfortable. This product has the ease of use and comfort that accomplishes the objectives of this patent.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A garment, a specific part wherein adapted to give off heat, the garment comprising:
a power;
a heating package located at the specific part of the garment and including:
a heating device energized by the power; and
a control circuit for controlling the heating status of the heating device; and
a switch assembly separated from and electrically connected with the heating package allowing control of the on/off status of the heating device.

2. The garment as claimed in claim 1, further comprising a wire electrically connecting the switch to the control circuit, the wire being enclosed by an electrically insulating material.

3. The garment as claimed in claim 1, wherein the garment has a torso area that contains the specific part and an appendage area where the switch assembly is positioned.

4. The garment as claimed in claim 3, wherein the appendage area further includes a container for accommodating the switch assembly.

5. The garment as claimed in claim 1, wherein the heating package further includes a thermally insulating material enclosing the heating device and the control circuit.

6. The garment as claimed in claim 1, wherein the heating package includes a temperature sensor and the control circuit includes a micro controller that receives signals from the temperature sensor.
